(19) United States
(12) Patent Application Publication
(10) Pub. No.: US 2005/0021709 A1
(43) Pub. Date: Jan. 27, 2005

(54) Method for creating a protocal-independent manager/agent relationship, in a network management system of a telecommunication network

(75) Inventors: Massimo Canali, Vimercate (IT); Marco Mussini, Milano (IT); Stefano Volonte, Monza (IT)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/721,285

(22) Filed: Nov. 26, 2003

(30) Foreign Application Priority Data
May 23, 2003 (EP) 03291223.0

(51) Int. Cl. G06F 15/173; G06F 15/16

(52) U.S. Cl. 709/223; 709/230

(57) ABSTRACT

The present invention relates to a method for creating a protocol-independent manager/agent relationship, in a Network Management System of a telecommunication network. This is achieved by means of the creation of a meta-model as a result of CSG (CORBA Strategy Gateway) tool chain. It permits to have a generic skeleton based on XML (extensible Markup Language) as a reference for NM application starting points. This skeleton permits an application to be independent from NE-NM interface descriptions irrespective of the NE-NM model and version supported. The skeleton describes the different implementations using unified rules based on the W3 standardized XML commands.

### TECHNICAL FIELD

The present invention relates to a method for creating a protocol-independent manager/agent relationship, in a Network Management System of a telecommunication network.

This application is based on, and claims the benefit of, European Patent Application No. 03291223.0 filed on May 23, 2003 which is incorporated by reference herein.

### BACKGROUND OF THE INVENTION

When a manager/agent relationship has to be detailed, the interface and the objects exchanged have to be defined.

This is strictly correlated with the specific model to use: i.e.

GDMO for Q3 network, IDL for CORBA, SMI for SNMP, etc. Moreover, in some cases, also the product release has to be taken into account.

Many models at Network Element level generate also different implementations at Network Management level to be able to understand the underlying dialects.

So there is a need to create an automatic model-independent manager/agent relationship, in particular for the use in the Network Management System of a telecommunication network, for application protocols over CORBA.

Known tools exist for transforming SQL database over CMISE or from XML to databases; however they are not optimized for both generic table-oriented databases and network management application protocols over CORBA, because they don't cover the full network management application needs. Hence manual operations are requested, and specific effort is required both for implementation and test phases.

### SUMMARY OF THE INVENTION

It is the main object of the present invention to provide a method for creating an automatic protocol-independent manager/agent relationship, in a Network Management System of a telecommunication network, wherein said method comprises the following steps:
a meta-model is created as a result of a CSG (CORBA Strategy Gateway) tool chain, so as to have a generic skeleton based on XML meta-language as a reference for Network Management application starting points based on:
a first set of core primitives, representing fundamental operations which are common to all management protocols;
a second set of “abstraction” primitives, which let the application perform abstract management operations;
the said CSG tool chain receiving in input specific protocol-dependent interface definitions, analysing them and generating as output different files containing different categories of information.

The basic idea of the present invention is to create a meta-model (written in XML language) as a result of the application of a generic, protocol-independent interface, named CSG (Corba Strategic Gateway) tool chain.

It permits to have a generic skeleton based on XML (extensible Markup Language) as a reference for NM application starting points. This skeleton permits an application to be independent from NE-NM interface descriptions irrespective of the NE-NM model and version supported.

The skeleton describes the different implementations using unified rules based on the W3 standardized XML commands.

(details can be taken directly from the W3 web site —http://www.w3.org/).

Through the creation of the CSG generic protocol-independent interface it is possible to reduce the effort needed to manage different NEs and to have a meta-model written in XML.

This solution makes it possible to hide the various differences among protocols.

A further advantage of having this meta-model is to have a XML based definition where the NE functionalities are taken into account in order to cover some lacks that can be found into the general-purpose standard models.

These functionalities are mainly the ones defined in the NMD model where the NE specific needs are covered with proprietary definitions.

These and further objects are achieved by means of an apparatus and method as described in the attached claims, which are considered an integral part of the present description.

### BRIEF DESCRIPTION OF THE DRAWINGS

The invention will become fully clear from the following detailed description, given by way of a mere exemplifying and non limiting example, to be read with reference to the attached drawing figures, wherein:

FIG. 1 shows a block diagram of the system in accordance with the invention;

FIG. 2 shows an example of CSG tool usage.

### BEST MODE FOR CARRYING OUT THE INVENTION

As known, XML is a language with shaping capabilities and can be used to support presentations of the same meaning in different forms. The format is added later by the presentation device, according to its capabilities, while the contents and logical structure is specified in the XML data. The XML language is described for example in http://www.w3.org/XML/. In the following some features of XML language are described.

XML is for structuring data—Structured data includes spreadsheets, address books, configuration parameters, financial transactions, and technical drawings. XML is a set of rules for designing text formats that let you structure your data. XML is not a programming language, and you don't have to be a programmer to use it or learn it. XML makes it easy for a computer to generate data, read data, and ensure that the data structure is unambiguous. XML avoids common pitfalls in language design: it is extensible, platform-independent, and it supports internationalization and localization. XML is fully Unicode-compliant.

XML looks a bit like HTML—Like HTML, XML makes use of tags (words bracketed by ‘<’ and ‘>’) and attributes (of the form name=“value”). While HTML specifies what each tag and attribute means, and often how the text between them will look in a browser, XML uses the tags only to delimit pieces of data, and leaves the interpretation of the data completely to the application that reads it.

XML is a family of technologies—The XML family is a growing set of modules that offer useful services to accomplish important and frequently demanded tasks, like the following. Xlink describes a standard way to add hyperlinks to an XML file. XPointer and XFragments are syntaxes in development for pointing to parts of an XML document. An XPointer is a bit like a URL, but instead of pointing to documents on the Web, it points to pieces of data inside an XML file. CSS, the style sheet language, is applicable to XML as it is to HTML. XLS is the advanced language for expressing style sheets. It is based on XSLT, a transformation language used for rearranging, adding and deleting tags and attributes. The DOM is a standard set of function calls for manipulating XML (and HTML) files from a programming language. XML Schemas help developers to precisely define the structures of their own XML-based formats: that is a language to provide means for defining the structure, content and semantics of XML documents; it also expresses shared vocabularies and allow machines to carry out rules made by people (the rules could involve filtering, collection of information, relationship between different data, etc.). There are several more modules and tools available or under development.

XML is modular—XML allows to define a new document format by combining and reusing other formats. Since two formats developed independently may have elements or attributes with the same name, care must be taken when combining those formats. To eliminate name confusion when combining formats, XML provides a namespace mechanism. XML Schemas is designed to mirror this support for modularity at the level of defining XML document structures, by making it easy to combine two schemas to produce a third which covers a merged document structure.

According to the invention, the generic, protocol-independent interface, named CSG (Corba Strategic Gateway), is created according to the following general principles.

First of all, a set of core primitives is identified in the input model. These primitives represent fundamental operations which are common to all management protocols, such as reading and writing attribute values to/from the managed agent. Through these generic primitives, a management application can be written, for the first time, in a protocol-independent way (though of course it remains model-dependent, which will always be true). If another agent with the same model, but different protocol, has to be managed, the management application is ideally not impacted at all.

Second, a set of “abstraction” primitives are defined. These primitives let the application perform abstract management operations which may have a direct, concrete equivalent primitive in some “rich” protocols but not in other “simpler” ones. An example can be the Action primitive, which is explicitly supported in CMIP but only implicitly supported (i.e. it may only be obtained as side effect of other operations) in SNMP. The abstraction primitives let the management application programmer write code that can assume these operations are practically available even when the underlying protocol does not support these concepts.

Third, as an option, several sets of optimized, protocol-oriented primitives are identified and transformed into core primitives. The protocol-oriented primitives can be present in some protocols.

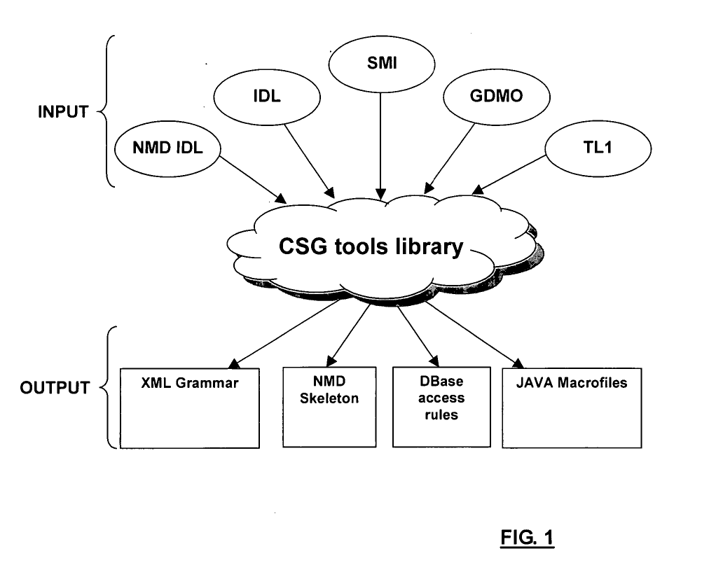

More particularly, with reference to FIG. 1, the CSG tool receives in input the proprietary interface definitions, for example:
NMD IDL, TL1: proprietary methods;
IDL: a CORBA method written in IDL language (Interface Data Language);
SMI: a method in SNMP protocol;
GDMO: a method in CMIP language.

The CSG tool analyses them and generates different output files containing different categories of information. These categories of information are the following:
XML grammar describing the content of the interface model;
NMD skeleton for NE specific information;
DBase independent access rules;
JAVA source files to provide a typed-based code immediately available from applications.

The XML meta-model is defined using the CSG tool. This tool receives in input the proprietary interface definitions, analyses them and outputs several files containing different categories of information. These set of information define the meta-language.

Hence the tool is able to decompose the input model into atomic objects, semantically meaningful. Afterwards it analyzes each atomic object identifying the relevant attributes and features such as name, syntax, access type, behaviour. As a result, each attribute is translated into output (e.g. XML/JAVA) format and moved in the proper output file. The number of input files may vary depending on which language has to be translated; while the meta language output files are always the same, so it could happen to have the split of attributes coming from one file into different output files.

The XML meta-language is composed of the following kinds of files:
XML Model D scriptor It describes grouping and containment relations between attributes and classes.
DTD Sch ma This schema describes the datatype of the attributes and their association with classes. It also specifies whether attributes are optional or mandatory, and their default value, if any. It may be used at run time to validate the stream of XML data coming from the agent using a validating XML parser.
XML Data ProfileIt contains type, access and other additional information in a format suitable for use by the manager for type/access rights checking and for configuring the GUI as appropriate to prevent errors, offering exactly the commands necessary to access the supported features.
DB Access rules It is a repository for identifying the operations that can be applicable to the attribute/object from a data base point of view: for example, read/write and create/delete permissions. It is useful for agent-side programming because such applications like Zero-installation clients have, by definition, no pre-installed database.
JAVA Macrofiles These files provide the Java management application developer with an API layer providing simplified access to model attributes and methods, with access control rules and syntax automatically enforced by construction. For example, no SET method will be generated for attributes with read-only access, whereas action methods will be generated with a signature containing all necessary arguments, of the appropriate types, as method parameters.
NMD Skeleton This file contains the definitions common to all the Network Elements NEs used by NM to manage the NE itself.

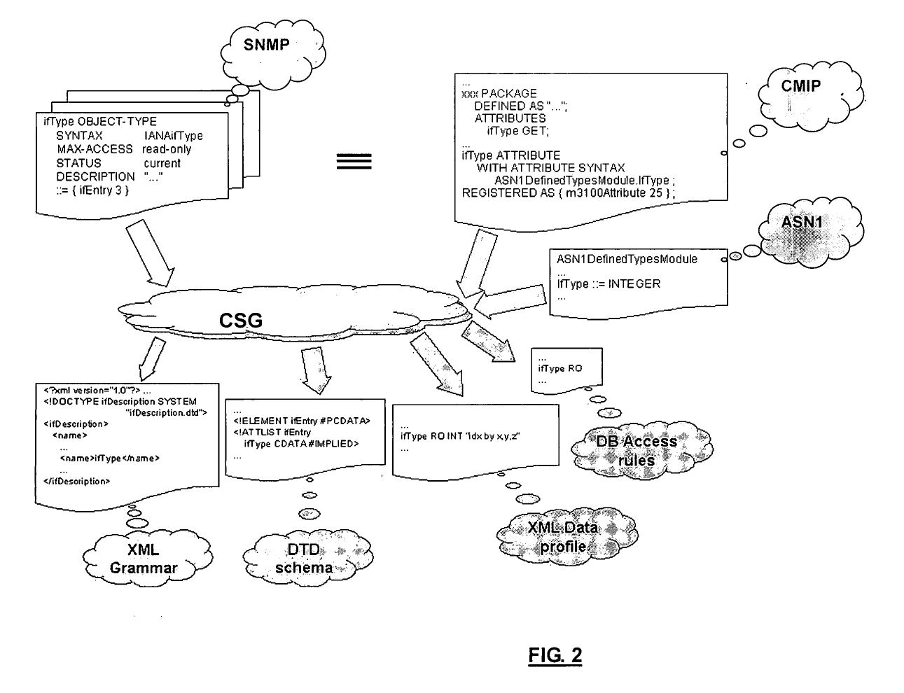

The FIG. 2 shows an example of definition of the meta-model starting from SNMP and CMIP protocols, where the same type of information are coded into SMI (Structure of Management Information) and GDMO.

The ASN1 input is relating to the definition made in the ASN1 (Abstract Syntax Notation) language of complex data structures and is used to define the other protocols into low level rules for the data transmission.

The input protocols are:

| | |
|---|---|
| SNMP: | ifType OBJECT-TYPE |

| | |
|---|---|
| SYNTAX | IANAifType |
| MAX-ACCESS | read-only |
| STATUS | current |

| | DESCRIPTION “.....” |
|---|---|
| | ::= { ifEntry 3 } |
| CMIP: | ......... |

xxxPACKAGE
DEFINED AS “.....”;
ATTRIBUTES

ifType GET;

.........
ifType ATTRIBUTE
WITH ATTRIBUTE SYNTAX

ASN1DefinedTypesModule.ifType;

| | REGISTERED AS { m3100Attribute 25 }; |
|---|---|
| ASN1: | ASN1DefinedTypesModule |

.........
IfType::=INTEGER
.........

The output meta-models defined are:

XML Grammar:
<?xml version=“1.0”?>......
<!DOCTYPE ifDescription SYSTEM “ifDescription.dtd”>
<ifDescription>

<name>

..........
<name>ifType</name>
..........

<ifDescription>
DTD schema:
.....
<!ELEMENT ifEntry #PCDATA>
<!AT TLIST ifEntry ifType CDATA#IMPLIED>
......
XML Data profil :
........
ifType RO INT “idx by x,y,z”
........
DB Access rules:
........
ifType RO
........

This model, focused on the management of a generic NE, is used between EML and NML.

The message is defined by one, or more, XML commands. The NMD part has the purpose to provide some NE family specific procedure, in order to give to the requestor the information in a protocol dependent way; e.g., the address of an interface is the “NSAP” for the Q3 world, “IP address+UDP port” for the SNMP, etc.

It is also evident that the NM does not care about the languages used.

Further implementation details will not be described, as the man skilled in the art is able to carry out the invention starting from the teaching of the above description.

The present invention can be advantageously implemented through a program for computer comprising program coding means for the implementation of one or more steps of the method, when this program is running on a computer. Therefore, it is understood that the scope of protection is extended to such a program for computer and in addition to a computer readable means having a recorded message therein, said computer readable means comprising program coding means for the implementation of one or more steps of the method, when this program is run on a computer.

Many changes, modifications, variations and other uses and applications of the subject invention will become apparent to those skilled in the art after considering the specification and the accompanying drawings which disclose preferred embodiments thereof. All such changes, modifications, variations and other uses and applications which do not depart from the spirit and scope of the invention are deemed to be covered by this invention.

1. Method for creating a protocol-independent manager/agent relationship, in a Network Management System, wherein said method comprises the following steps:
a meta-model is created as a result of a CSG (CORBA Strategy Gateway) tool chain, so as to have a generic skeleton based on XML meta-language as a reference for Network Management application starting points based on:
a first set of core primitives, representing fundamental operations which are common to all management protocols;
a second set of “abstraction” primitives, which let the application perform abstract management operations;
the said CSG tool chain receiving in input specific protocol-dependent interface definitions, analysing them and generating as output different files containing different categories of information.

2. Method according to claim 1, wherein said generic skeleton based on XML meta-language further comprises a third set of optimized, “protocol-oriented” primitives, identified and transformed into core primitives.

3. Method according to claim 2, wherein said XML meta-language is composed of the following kinds of files:
“XML Model Descriptor”, describing grouping and containment relations between attributes and classes;
“DTD Schema”, describing the datatype of the attributes and their association with classes;
“XML Data Profile”, containing type, access and other additional information in a format suitable for use by the manager for type/access rights checking and for configuring a Graphical User Interface;
“DB Access rules”, a repository identifying the operations that can be applicable to the attribute/object from a data base point of view;
“JAVA Macrofiles”, files providing the Java management application PAGE developer with an API layer providing simplified access to model attributes and methods, with access control rules and syntax automatically enforced by construction;
“NMD Skeleton”, a file containing the definitions common to all the Network Elements (NEs) used by the Network Management to manage the NEs.

4. Network Management System of a telecommunication network, wherein said network management system comprises means for implementing the method of claim 1.

5. Computer program comprising computer program code means adapted to perform all the steps of claim 1 when said program is run on a computer.

6. A computer readable medium having a program recorded thereon, said computer readable medium comprising computer program code means adapted to perform all the steps of claim 1 when said program is run on a computer.
